(19) United States
(12) Patent Application Publication
(10) Pub. No.: US 2002/0104344 A1
(43) Pub. Date: Aug. 8, 2002

(54) Lock mechanism for deterring access

(76) Inventor: Raymond Nieves, Bronx, NY (US)

Correspondence Address: Robert T. Maldonado, Cooper & Dunham LLp, 1185 Avenue of the Americas, New York, NY, 10036, US

(21) Appl. No.: 09/777,055

(22) Filed: Feb. 5, 2001

(51) Int. Cl. E05B 9/08

(52) U.S. Cl. 70/370

(57) ABSTRACT

A lock mechanism for removably covering an opening in an object includes a face plate having a hole into which a sleeve having a fixed cam is fixedly mounted. A barrel is fixedly mounted in the sleeve, and a lock cylinder is removably received in the barrel. A rotating shaft extends from an end of the lock cylinder, and a rotating cam is mounted on the rotating shaft. A removable nut fastens the lock cylinder to the face plate. The lock mechanism is insertable in the opening of the object to removably cover the opening when the fixed cam and the rotating cam are aligned. When the shaft of the lock cylinder is rotated in one direction, the rotating cam rotates with it, so that the rotating cam is placed out of alignment with the fixed cam. This position is a locked position, at which position the lock mechanism is locked to the object so that the opening is inaccessible. When the shaft of the lock cylinder is rotated in an opposite direction, the rotating cam rotates with it to the unlocked position, at which the rotating cam is aligned with the fixed cam, so that the lock mechanism can be removed from the object and the opening can be accessible.

### FIELD OF THE INVENTION

The present invention relates to a new lock system designed to be attached to the bumper of a vehicle to deter theft of the spare tire from that vehicle, and, in particular, to a dual cam lock that can be inserted in an opening of a vehicle and locked in place.

### BACKGROUND OF THE INVENTION

In recent years, the sports utility vehicle (“SUV”) has become an increasingly popular vehicle. The SUV is designed so that its chassis is raised higher off the ground than that of a standard automobile. As a result, the spare tire on an SUV often is stored under the chassis. In order to access the spare tire, the vehicle operator inserts a screwdriver or crow bar into an opening formed in the rear bumper of the vehicle which engages a release mechanism that lowers the spare tire. Typically, this opening is not covered in any way, so anyone has access to it, and there is no security mechanism to prevent the spare tire from being stolen.

### SUMMARY OF THE INVENTION

It is therefore an important or principal object of the present invention to provide a lock mechanism for covering the opening in a bumper of a vehicle to prevent access to the release mechanism which lowers the spare tire stored under the chassis of the vehicle, which is portable and convenient to use.

The foregoing objects are achieved, and the disadvantages of other devices overcome by providing a lock mechanism which can be inserted into the opening formed in the bumper of a vehicle and locked into place. The lock mechanism has a dual cam operation, and is locked and unlocked with a key. Initially, the two cams are aligned so that the lock mechanism can be inserted in the hole. After insertion, one cam is rotated so that the lock mechanism is locked in place and cannot be removed without the key. With the lock mechanism of the present invention, the opening is covered and locked, thus preventing the tire from being stolen from the vehicle. When in a locked position, the lock mechanism remains attached to the bumper of the vehicle unless and until the mechanism is unlocked and removed by the user.

### BRIEF DESCRIPTION OF THE DRAWINGS

Further objects, features and advantages of the invention will become apparent upon review of the following detailed description of the preferred embodiments, taken in conjunction with the following drawings, in which:

FIG. 1 is an exploded view of the lock mechanism according to the present invention;

FIG. 2 is a plan view of the lock mechanism according to the present invention, shown installed on a vehicle bumper;

FIG. 3 is a partial cross-section view taken along line 3-3 of FIG. 2 of the lock mechanism attached to the bumper in the locked position;

FIG. 4 is a partial cross-section view taken along line 3-3 of FIG. 2 of the lock mechanism illustrated in the open position;

FIG. 5 is a perspective view of the lock mechanism attached to the bumper of a vehicle according to the present invention;

FIG. 6 is a perspective view of a vehicle with the lock mechanism attached to the bumper according to the present invention; and

FIG. 7 is a partial cross-section view taken along line 3-3 of FIG. 2 of the lock mechanism according to a second embodiment of the present invention, showing the lock mechanism engaging the release mechanism.

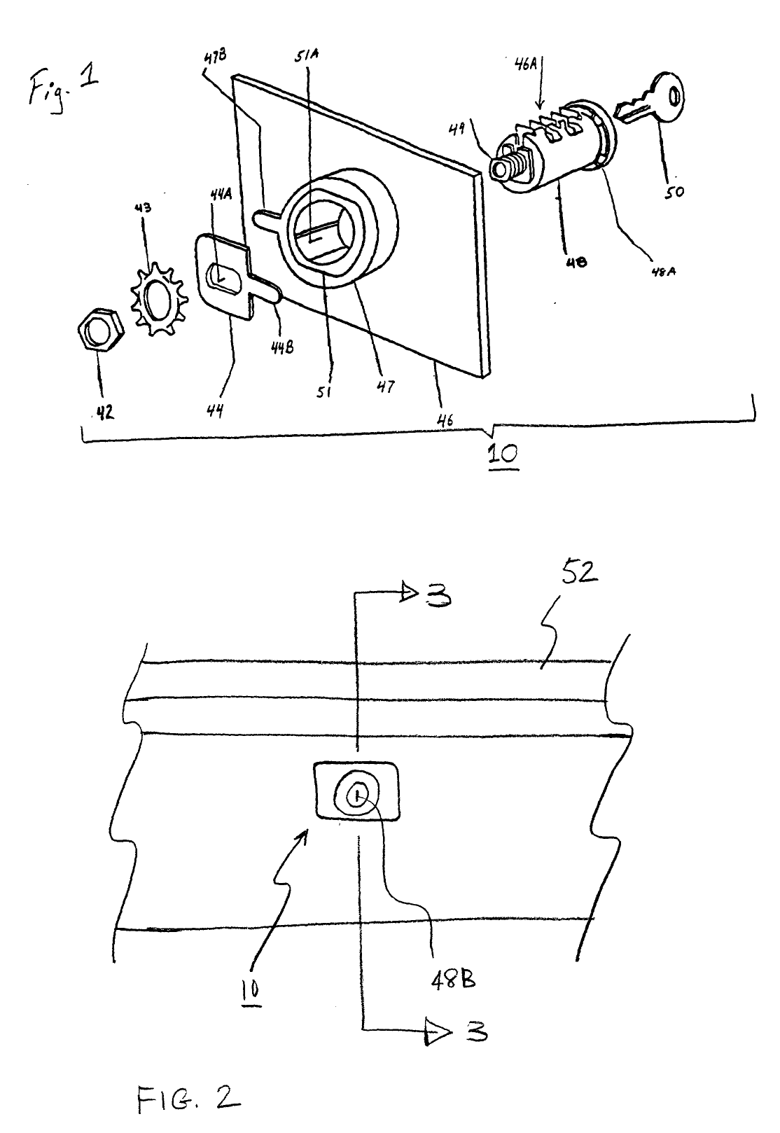

### DETAILED DESCRIPTION OF THE INVENTION

Referring now to FIG. 1, the lock mechanism 10 includes a face plate 46 which may be of any shape, having a hole formed therethrough for receiving a sleeve 47, which is fixedly attached to the face plate 46 by welding or other means well-known to one skilled in the art. Barrel 51 is fixedly received in sleeve 47 by welding, press fitting, or other means, and has a hole 51A formed therethrough. Sleeve 47 has cam 47B welded thereto, in a fixed position, as shown in FIG. 1. Thus, cam 47B is stationary with respect to the face plate 46, and is not rotatable.

Lock cylinder 48 has locking elements 46A formed along its circumference, and a shoulder 48A at one end and a threaded protrusion 49 at an opposite end. The shoulder 48A has an opening or slot 48B for receiving a key 50. The lock cylinder 48 is inserted in the hole 51A of barrel 51 and the shoulder 48A of the lock cylinder 48 abuts the face plate 46 of the lock mechanism 10.

A rotating member 44 has a hole 44A formed therethrough and a cam 44B welded to the rotating member 44 so that the cam 44B is fixedly mounted with respect to the rotating member 44 and is movable therewith. The threaded protrusion 49 of lock cylinder 48 is received in the hole 44A of the rotating member 44. The hole 44A of the rotating member 44 may have an oblong shape which mates with the shape of the threaded protrusion 49, so that rotating member 44 rotates with threaded protrusion 49 of the lock cylinder 48. The lock cylinder 48 is attached to the face plate 46 by a lock washer 43 and a nut 42 fitted over the threaded protrusion 49 of the lock cylinder 48 and removably tightened to hold the lock cylinder 48 in place.

Lock cylinder 48 may be a conventional key actuated lock cylinder having locking elements 46A which interact with holes in barrel 51 to prevent rotation of the cylinder unless the proper key 50 is received therein.

Shoulder 48A acts as a stop to prevent lock cylinder 48 from completely passing through barrel 51. Rotating member 44 resists the force applied to shoulder 48A by action of attaching nut 42 to threaded protrusion 49.

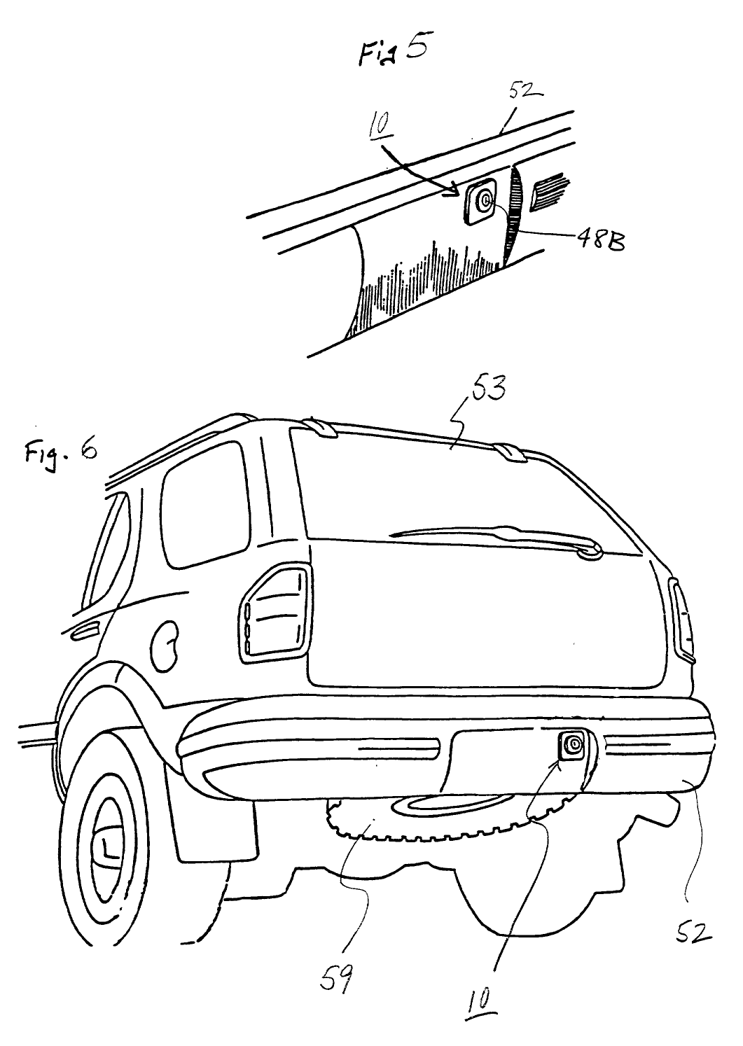

The lock mechanism 10 is inserted into a hole (not shown) in the bumper 52 of a vehicle 53, as shown in FIGS. 4 and 5 and as will be explained hereinafter.

When in an initial, unlocked state, the fixed cam 47B is aligned with the movable cam 44B, as shown in FIG. 4. The outer dimensions of the sleeve 47 approximate the size of the hole in the bumper 52, so that if the cams 47B, 44B are not aligned, the lock mechanism 10 will not fit in the hole. In the unlocked, aligned position, the locking mechanism 10 can either be inserted into the hole in the bumper 52 as shown in FIGS. 5 and 6, or it can be removed from the bumper 52 so that the mechanism for releasing the spare tire can be accessed and operated.

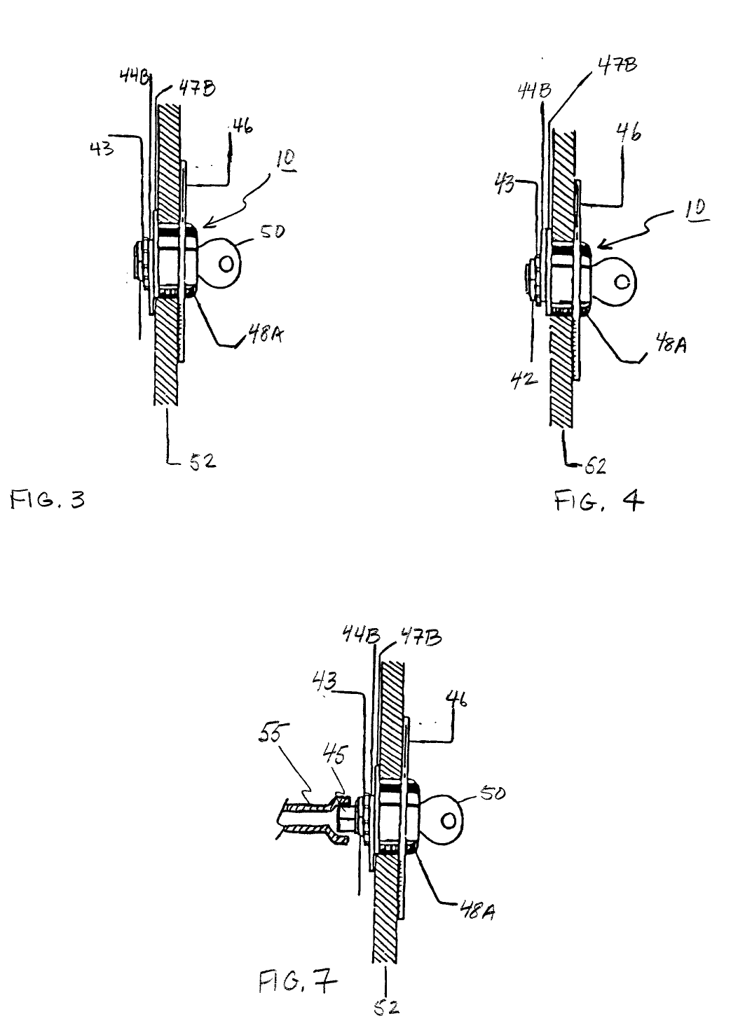

The operation of the lock mechanism of the present invention may be understood with reference to FIGS. 3 and 4. After the lock mechanism 10 is inserted into the hole in the bumper 52, the key 50 is inserted in the slot 48B of the lock cylinder 48 and rotated so that the threaded protrusion 49 and the rotating member 44 also are rotated therewith. Thus, the cam 44B is rotated with respect to the cam 47B so that the cams 44B, 47B are no longer aligned. In this locked position, shown in FIG. 3, the lock mechanism 10 is fixedly attached to the bumper 52 of the vehicle 53, and cannot be removed until the rotating member 44 is rotated to the unlocked position. When the key 50 in inserted in the slot 48B of the lock cylinder 48 and rotated, the cams 44B, 47B realign, and the lock mechanism 10 can be removed from the hole to provide access.

In another embodiment, as shown in FIG. 7, the lock mechanism 10 includes an engagement member 45 attached to the end of the threaded portion 49 of the lock cylinder 48. The engagement member 45 is of such a shape so as to match and the mate with the shape of the release mechanism 55, which is a crank shaft or the like which is turned to lower the spare tire 59. The shape of the engagement member 45 may be hexagonal. Thus, when the lock mechanism 10 is attached to the bumper 52, the engagement member 45 engages the release mechanism 55 and locks it in place so that the release mechanism cannot be rotated, and the spare tire cannot be lowered and removed from the vehicle.

While the invention has been described in terms of a covering for an access hole formed in the bumper of a vehicle, the lock mechanism can be used to cover any hole for which restricted access is desired.

Having described specific preferred embodiments of the present invention with reference to the accompanying drawings, it is to be understood that the invention is not limited to those precise embodiments, and that various changes and modifications may be effected therein by one skilled in the art without departing from the spirit or the scope of the present invention as defined in the appended claims.

What is claimed is:

1. A lock mechanism for removably covering an opening in an object comprising:
a face plate having a hole;
a sleeve fixedly mounted in the hole of the face plate, the sleeve having a fixed cam protruding therefrom;
a barrel fixedly mounted in the sleeve;
a lock cylinder removably received in the barrel and having a rotating protrusion extending from an end thereof;
a rotating cam mounted on the rotating protrusion of the lock cylinder;
securing means for removably attaching the lock cylinder to the face plate;
wherein the lock mechanism is insertable in the opening when the fixed cam and the rotating cam are aligned,
and wherein the protrusion of the lock cylinder is rotatable in a first direction for rotating the rotating cam out of alignment with the fixed cam to a locked position for locking the locking mechanism to the object so that the opening is inaccessible,
and wherein the protrusion of the lock cylinder is rotatable in a second direction opposite the first direction for rotating the rotating cam into alignment with the fixed cam to an unlocked position so that the lock mechanism can be removed from the object and the opening can be accessible.

2. The lock mechanism as claimed in claim 1, wherein the sleeve is cylindrical and an outer diameter of the sleeve is approximately equal to the diameter of the opening in the object.

3. The lock mechanism as claimed in claim 1, wherein the lock mechanism is mounted on a bumper of a vehicle so as to prevent unauthorized access to a mechanism for releasing a spare tire stored underneath the vehicle, further comprising an engagement member mounted on the end of the rotating protrusion for engaging the mechanism for releasing the spare tire.

4. The lock mechanism as claimed in claim 1, wherein the rotating protrusion of the lock cylinder is threaded.

5. The lock mechanism as claimed in claim 4, wherein the securing means comprises a nut removably attached to the threaded protrusion of the lock cylinder.

6. The lock mechanism as claimed in claim 5, further comprising a washer disposed between the nut and the rotating cam.

7. The lock mechanism as claimed in claim 4, wherein the rotating cam has an opening which engages the threaded protrusion of the lock cylinder.

8. The lock mechanism as claimed in claim 7, wherein the opening in the rotating cam has an oblong shape.

9. The lock mechanism as claimed in claim 1, wherein at the locked position the rotatable cam is disposed 180 degrees relative to the fixed cam.

10. The lock mechanism as claimed in claim 1, wherein the end of the lock cylinder comprises a first end, and wherein the lock cylinder comprises locking elements which engage the barrel and a shoulder at a second end opposite the first end which abuts the face plate upon insertion of the lock cylinder in the barrel.

11. The lock mechanism as claimed in claim 1, further comprising a key for inserting in the locking cylinder for unlocking the lock cylinder so that the rotatable cam is movable with respect to the fixed cam.

12. The lock mechanism as claimed in claim 1, wherein the object is a bumper of a vehicle.

13. The lock mechanism as claimed in claim 1, wherein the sleeve is attached to the face plate by welding.

14. The lock mechanism as claimed in claim 1, wherein the barrel is mounted in the sleeve by welding.

15. The lock mechanism as claimed in claim 1, wherein the barrel is mounted in the sleeve by press fitting.

16. A lock mechanism for removably covering an opening in a bumper of a vehicle so as to prevent unauthorized access to a mechanism for releasing a spare tire stored underneath the vehicle, comprising:
a face plate having a circular hole formed therethrough;
a cylindrical sleeve fixedly mounted in the hole of the face plate, the sleeve having a fixed cam protruding therefrom and having a diameter approximately equal to the diameter of the opening in the bumper of the vehicle;
a ring-shaped barrel fixedly mounted in the sleeve;
a cylindrical lock cylinder removably received in the barrel and having a threaded rotating protrusion with an oblong cross section extending from a first end thereof and a shoulder extending from a second end thereof opposite the first end, the rotating protrusion rotating upon actuation by a key inserted in the lock cylinder and rotated;
a rotating cam having an oblong opening fitted on the threaded rotating protrusion of the lock cylinder;
a nut removably attached to an end of the threaded rotating protrusion for removably attaching the lock cylinder to the face plate;
a washer disposed between the nut and the rotating cam;
wherein the lock mechanism is insertable in the opening of the bumper when the fixed cam and the rotating cam are aligned,
and wherein the protrusion of the lock cylinder is rotatable in a first direction for rotating the rotating cam out of alignment with the fixed cam to a locked position for locking the locking mechanism to the bumper so that the opening is inaccessible, and wherein at the locked position the rotatable cam is disposed 180 degrees relative to the fixed cam,
and wherein the protrusion of the lock cylinder is rotatable in a second direction opposite the first direction for rotating the rotating cam into alignment with the fixed cam to an unlocked position so that the lock mechanism can be removed from the bumper and the opening can be accessible.

17. The lock mechanism as claimed in claim 16, wherein the sleeve is attached to the face plate by welding.

18. The lock mechanism as claimed in claim 16, wherein the barrel is mounted in the sleeve by welding.

19. The lock mechanism as claimed in claim 16, wherein the barrel is mounted in the sleeve by press fitting.

20. A lock mechanism for removably covering an opening in a bumper of a vehicle so as to prevent unauthorized access to a mechanism for releasing a spare tire stored underneath the vehicle, comprising:
a face plate having a hole formed therethrough;
a cylindrical sleeve fixedly mounted in the hole of the face plate, the sleeve having a fixed cam protruding therefrom and having a diameter approximately equal to the diameter of the opening in the bumper of the vehicle;
a ring-shaped barrel fixedly mounted in the sleeve;
a cylindrical lock cylinder removably received in the barrel and having a threaded rotating protrusion extending from a first end thereof and a shoulder extending from a second end thereof opposite the first end, the rotating protrusion rotating upon actuation by a key inserted in the lock cylinder and rotated;
a rotating cam having an opening fitted on the threaded rotating protrusion of the lock cylinder;
a nut removably attached to an end of the threaded rotating protrusion for removably attaching the lock cylinder to the face plate;
a washer disposed between the nut and the rotating cam;
an engagement member mounted on the end of the threaded rotating protrusion for engaging the mechanism for releasing the spare tire;
wherein the lock mechanism is insertable in the opening of the bumper when the fixed cam and the rotating cam are aligned,
and wherein the protrusion of the lock cylinder is rotatable in a first direction for rotating the rotating cam out of alignment with the fixed cam to a locked position for locking the locking mechanism to the bumper so that the opening is inaccessible, and wherein at the locked position the rotatable cam is disposed 180 degrees relative to the fixed cam, and the engagement member engages the mechanism for releasing the spare tire in the locked position,
and wherein the protrusion of the lock cylinder is rotatable in a second direction opposite the first direction for rotating the rotating cam into alignment with the fixed cam to an unlocked position so that the lock mechanism can be removed from the bumper and the opening can be accessible.
